(19) United States
(12) Patent Application Publication
(10) Pub. No.: US 2024/0163540 A1
(43) Pub. Date: May 16, 2024

(54) Image Processing Architecture For Composite Focal Plane Array (CFPA) Imaging System

(71) Applicant: Meta Materials Inc., North Billerica, MA (US)

(72) Inventors: Jonathan Edwards, Brookeville, MD (US); Daniel George Haas, Lothian, MD (US); Samuel Hanchett Henderson, Alexandria, VA (US); Yiannis Antoniades, Fulton, MD (US); David Chester, Edgewater, MD (US)

(21) Appl. No.: 18/389,213

(22) Filed: Nov. 13, 2023

Related U.S. Application Data
(60) Provisional application No. 63/424,837, filed on Nov. 11, 2022.

(51) Int. Cl. H04N 23/55; G06T 3/40; G06V 10/10; G06V 10/25; G06V 20/17; H04N 21/2187

(52) U.S. Cl. CPC H04N 23/55; G06T 3/4038; G06V 10/16; G06V 10/25; G06V 20/17; H04N 21/2187

(57) ABSTRACT

The present disclosure is directed to composite focal plane array (CFPA) imaging systems with techniques and architectures for efficient video data processing and providing video products from such systems.

### CROSS REFERENCE TO RELATED APPLICATION

This application claims the benefit under 35 U.S.C. § 119(e) from U.S. Provisional Application No. 63/424,837, entitled “Image Processing Architecture For Composite Focal Plane Array (CFPA) Imaging System,” filed on Nov. 11, 2022. The entirety of the disclosure of the foregoing document is incorporated herein by reference.

### TECHNICAL FIELD

The present disclosure is in the field of imaging systems. More specifically, this disclosure relates to composite focal plane array (CFPA) imaging systems and image processing architectures for such CFPA imaging systems

### BACKGROUND INFORMATION

Wide area persistent motion imaging commonly involves continuous surveillance of a large area using an airborne camera system capable of imaging visible and/or IR wavelengths and is increasingly used for public safety, insurance, disaster relief, search and rescue, smart cities, border surveillance and numerous other use cases. It is an emerging technology, which is creating a new paradigm in providing large scale context relevant for machine learning for the commercial, public safety and military applications.

Gigapixel video can be produced by stitching together individual video streams from multiple focal plane arrays (FPAs), each composed of megapixel sensors, e.g., a staring array, or staring-plane array, e.g., an image sensor composed of an array (typically rectangular) of light-sensing pixels (e.g., visible or IR-sensing pixels) at the focal plane of a lens, such as the lenses used in cell phone cameras and single-lens reflex (SLR) cameras, suitable for the operational wavelength of the FPA sensors, e.g., individual sensors of the FPA. Typical FPA sensors have pixel pitches as small as 0.6 microns to minimize the size of the cameras using FPA sensors. A CFPA typically consists of three or more groups of FPA sensors, each comprising multiple FPAs and its own lens. When pointed to the same ground point, substrates having a CFPA arrangement of sensors, e.g., a CFPA board, can produce staring motion imagery at gigapixel resolution.

Very wide area persistent surveillance is typically performed using airborne platforms using cameras which produce gigapixel-resolution images, e.g., gigapixel cameras. In order to be able to distinguish and track multiple events on the ground, including people, small animals, vehicles, etc. the cameras should cover large ground areas, on the order of tens to hundreds of square kilometers, and have very high spatial resolution (e.g., a per pixel spatial resolution of about 15 cm or more). Since there are no single gigapixel FPAs, systems with multiple FPAs are used to create wide area mosaics persistently.

Using CFPA imaging systems can provide adequate wide-area coverage at adequate temporal resolution to distinguish stationary and moving objects. These systems also have enough spatial resolution to detect and track individuals. However, the volume of imagery covering an area the size of a city with adequate resolution to distinguish vehicles and persons is of terabyte class for a single sensor/day. This presents a challenge for real-time surveillance because telemetry links are incapable of downloading all of the image data in real-time. Therefore, what is needed is a system that capable of simultaneously fulfilling multiple live video window requests from a wide-area surveillance platform over a telemetry link having a bandwidth insufficient to transmit all the real-time image data acquired by the platform.

Furthermore, there is a need to reduce (e.g., minimize) the size, weight, and power (SWaP) of the onboard processing system to reduce platform integration impact—smaller imaging systems can be used with increasingly small unmanned aerial systems. Processor SWaP can be lessened by reducing the data interconnect and computation requirements within the processor to fulfill live video requests. Therefore, what is needed is a system and processing architecture that fulfills live video window requests from a WAMI system in such a way as to reduce data movement within the processor while simultaneously reducing processing computation to create the video window.

### SUMMARY

It has been discovered that onboard parallel processing of image data necessary for fulfilling multiple simultaneous live video window requests can be used to reduce bandwidth demands on a wireless data link needed to fulfill the requests. This discovery has been exploited to develop the present disclosure, which in part is directed to architectures for image processing subsystems of wide-area CFPA imaging systems capable of fulfilling such live video window requests. The architecture also can reduce internal processor data movement requirements and can implement only the minimal computations to fulfill requests.

In general, in a first aspect, the disclosure features a system, including: a composite focal plane array (CFPA) imaging system installed on an airborne platform, the CFPA imaging system including: a CFPA camera with a plurality of focal plane array (FPA) sensor modules, the CFPA camera including optics to image a scene in a field of view onto the FPA sensor modules such that each FPA sensor module acquires an image of a different portion of the scene; an image processing subsystem including a plurality of nodes in communication with the global client node via one or more interconnects, each node being programmed to process image data from the CFPA camera according to a video window corresponding to a scene area of interest; and a server system remote from the airborne platform, the server system being in communication with the airborne platform via a wireless connection, the server system being configured to receive live video requests from one or more clients over a network and deliver, to the one or more clients over the network, a live video feed of the region of interest of the scene selected by the client.

Examples of the system can include one or more of the following features and/or features of other aspects. For example, the airborne platform can be an unmanned aerial vehicle.

The FPA sensor modules of the CFPA camera can be arranged in sensor groups and the optics of the CFPA camera can include multiple lens assemblies, each lens assembly corresponding to one of the sensor groups. The CFPA camera can include image readout electronics configured to receive image data from each of the FPA sensor modules and transmit the image data to the image processing subsystem.

The image processing subsystem can be programmed to project and resample images for the one or more live video feeds according to a total number of simultaneous live video feeds and a bandwidth of the wireless connection between the airborne platform and the server system.

The plurality of nodes can include a global processing node programmed to perform a global registration of the image data from the FPA sensor modules.

The plurality of nodes can include a global processing node programmed to perform a geometric calibration of the image data from the FPA sensor modules.

The plurality of nodes can include a global processing node programmed to monitor image quality of the image data from the FPA sensor modules.

The plurality of nodes can include multiple exploitation nodes each having a video window processing module programed to process image data to provide processed image data according to one of the live video requests. The image data processing by the video window processing module can include mosaicking regions-of-interest of FPAs corresponding to a video window according to one of the live video requests.

The plurality of nodes can include multiple exploitation nodes each programmed to project and resample imagery corresponding to the video window assigned to the exploitation node.

The image processing subsystem can include a plurality of processor units, each of the plurality of nodes comprising a corresponding one of the processor units. Each processor unit can include a graphics processing unit (GPU). In some examples, each processor unit includes a field programmable gate array (FPGA) and/or an application specific integrated circuit (ASIC).

The server system can be configured to receive forensic track requests from one or more clients over the network and to deliver, to the one or more clients over the network, a video feed of according to the forensic video request.

The server system can be configured to receive wide area motion imaging (WAMI) track requests from one or more clients over the network and to deliver, to the one or more clients over the network, a track according to the WAMI track request.

In general, in a further aspect, the disclosure features a method for simultaneously providing multiple live video windows to different clients from an airborne platform, the method includes: receiving, at the airborne platform from a remote server via a wireless transmission, requests for the multiple live video windows from different clients; acquiring a sequence of image frames using a composite focal plane array (CFPA) imaging system of a scene installed on the airborne platform, the scene including scene areas of interest corresponding to the video windows requested; for each of the video window requests, determining one or more focal plane array (FPA) regions of interest (ROIs) sufficient to fulfill the requests by using request parameters and a geometric sensor model; for each of the video window requests, processing, at a corresponding node of an image processing subsystem of the CFPA imaging system, image data from the ROIs according to the video window request; wirelessly transmitting, from the image processing subsystem to the remote server, the image data processed by the image processing subsystem; and delivering, by the remote server over a network to the different clients, the image data for live video windows for the respective clients.

Examples of the method can include one or more of the following features and/or features of other aspects. For example, each video window request can be assigned by the image processing subsystem to a corresponding node and the nodes process the image data for their video window request in parallel. Processing of the image data at each node can include one or more of the following operations: non-uniformity correction, video stream region of interest (ROI) selection and distribution, color interpolation and transformation, contrast and imagery enhancement, geometric video image formation, and jitter stabilization. Each node can process image data corresponding only to the video window assigned to that node.

The live video windows can be delivered to the clients while the airborne platform moves relative to the scene.

Further details and embodiments and methods and techniques are described in the detailed description below. This summary does not purport to define the invention. The invention is defined by the claims.

### DESCRIPTION OF THE DRAWINGS

The foregoing and other objects of the present disclosure, the various features thereof, as well as the disclosure itself may be more fully understood from the following description, when read together with the accompanying drawings in which:

FIG. 1A is a diagrammatic representation of a top view of a single-substrate CFPA with three lens groups in a distributed configuration in accordance with many examples of the disclosure;

FIG. 1B is a diagrammatic representation of a perspective view of a CFPA camera with three lens assemblies imaging to a single CFPA board in accordance with many examples of the disclosure;

FIG. 1C is a diagrammatic representation of a composite image formed using a CFPA with three lens groups in a brick wall configuration in accordance with many examples of the disclosure;

FIG. 1D is a diagrammatic representation of a portion of the composite image shown in FIG. 1C showing image overlap in a calibrated system in accordance with many examples of the disclosure;

FIG. 2 is a diagrammatic representation of an example of a CFPA imaging system in accordance with many examples of the disclosure;

FIG. 3 is a diagrammatic representation of an airborne platform mounted with a CFPA camera imaging a target in accordance with many examples of the disclosure;

FIG. 4 is a diagrammatic representation of a system for providing live video windows to clients from an airborne platform-based CFPA imaging system;

FIG. 5 is a diagrammatic representation of an example computer system in accordance with many examples of the disclosure;

FIG. 6 is a diagrammatic representation of a process to assemble video streams for multiple users from a sequence of mosaic images of a contiguous geographic region according to many examples of the present disclosure;

FIG. 7 is a diagrammatic representation of a mosaic image formed from four composite focal plane sub array images according to many examples of the present disclosure;

FIG. 8 is a flow chart diagrammatic representation of a method for providing a video stream to a user according to many examples of the present disclosure;

FIG. 9 is a flow chart diagrammatic representation of a method for processing of FPA image data into video streams according to many examples of the present disclosure; and

FIG. 10 is a diagrammatic representation of a computer system according to many examples of the present disclosure.

### DETAILED DESCRIPTION

The disclosures of these patents, patent applications, and publications in their entireties are hereby incorporated by reference into this application in order to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated.

For the purposes of explaining the invention well-known features of image processing for technology known to those skilled in the art of multi-camera imaging arrays have been omitted or simplified in order not to obscure the basic principles of the invention. Parts of the following description will be presented using terminology commonly employed by those skilled in the art of optical design. It should also be noted that in the following description of the invention repeated usage of the phrase “in one embodiment” does not necessarily refer to the same embodiment.

As used herein, the articles “a” and “an” refer to one or to more than one (e.g., to at least one) of the grammatical object of the article. By way of example, “an element” means one element or more than one element. Furthermore, use of the term “including” as well as other forms, such as “include,” “includes,” and “included,” is not limiting. Any references to ‘above’ or ‘below’, ‘upper’ or ‘lower’ herein refer to an orientation of the photovoltaic cell in which the IR radiation is incident at the top of the film.

As used herein, the term “focal plane array” or “FPA” refers to an image sensor composed of an array of sensor elements (e.g., light sensing pixels) arranged at the focal plane of an imaging unit, such as an imaging lens assembly (e.g., a single or compound lens).

As used herein, a “FPA sensor module” is a modular FPA. In addition to the FPA, a FPA sensor module can include additional components such as packaging for integrated circuits and/or connectors or interfaces for connecting the FPA sensor modules to other components.

As used herein, a “composite focal plane array” or “CFPA” is an image sensor composed of multiple FPAs arranged at a common focal plane, e.g., of a single imaging unit or multiple imaging units.

As used herein, the term “sensor group” refers to a grouping of FPA sensor modules arranged in a field of view of an optical imaging unit, such as an imaging lens assembly.

As used herein, the term “video window” refers to a subset of data generated by a WAMI sensor that is formed from, potentially, multiple regions of individual focal plane data mosaicked together and downlinked as image sequences (i.e., video).

As used herein, the term “region of interest” or “ROI” refers to a subset of a single FPA sensor data, or data from multiple FPAs, used to form a video window.

Here and throughout the specification, reference to a measurable value such as an amount, a temporal duration, and the like, the recitation of the value encompasses the precise value, approximately the value, and within ±10% of the value. For example, here 100 nanometer (nm) includes precisely 100 nm, approximately 100 nm, and within ±10% of 100 nm.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components have not been described in detail to avoid obscuring the examples described.

The present disclosure provides systems and techniques for generating seamless wide area mosaics, images and video streams from CFPA imaging systems. The CFPA imaging system utilizes image overlap designed into the placement of the imaging sensor modules within the focal plane of mounted lenses. Given the size of WAMI imagery and use of multiple camera front-end electronics, the approach can also applied in a distributed acquisition system where subsets of acquired focal planes reside on separate processing nodes.

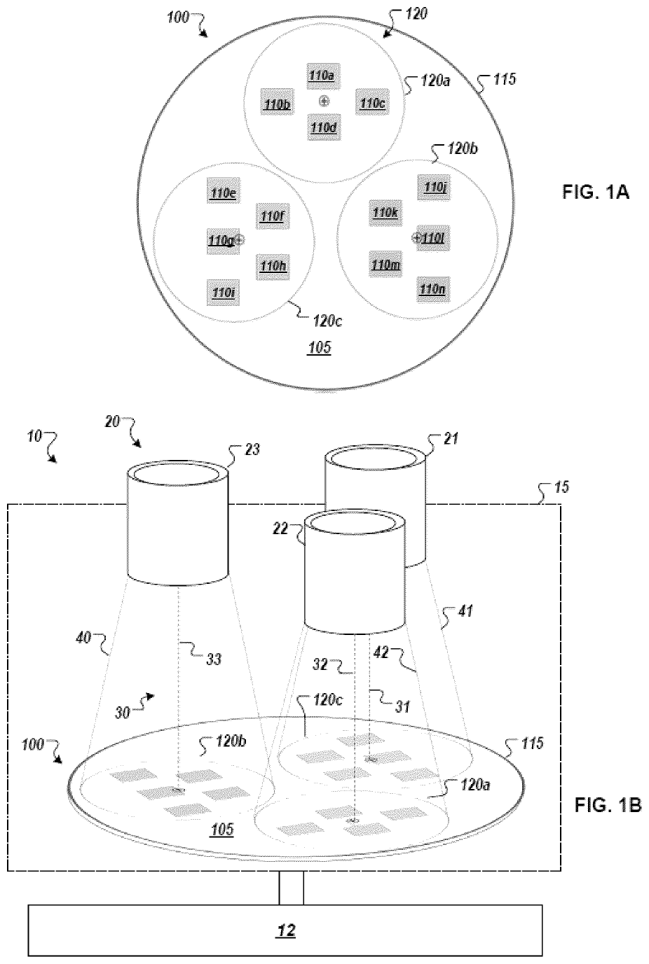

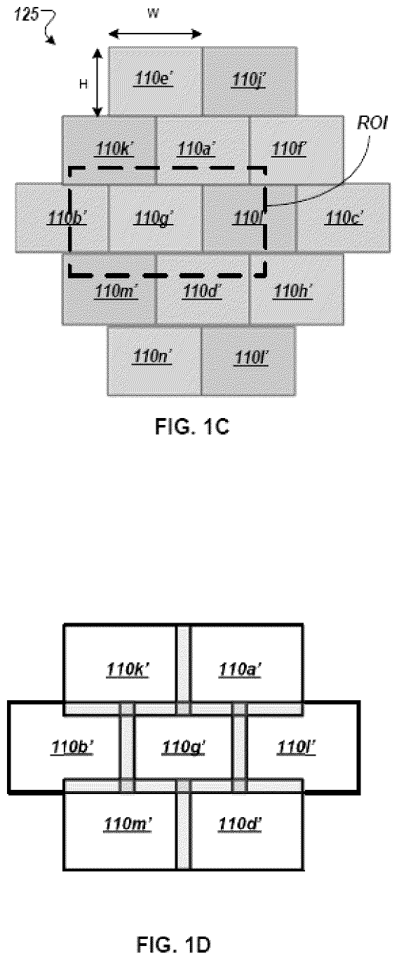

An exemplary imaging system is shown in FIGS. 1A and 1B. This system includes, in part, a CFPA camera 10 with three lens assemblies 21-23 and a CFPA board 100 is shown in FIGS. 1A and 1B. The CFPA camera 10 is interfaced with an image processing subsystem 12, arranged in close proximity to the CFPA camera 10. As will be described in more detail below, image processing subsystem 12 processes image data from the CFPA camera 10 to generate composite images, i.e., images composed of image data from more than one of the FPA sensor modules in CFPA camera 10. The image processing includes applying a sensor geometric calibration model to the image data in order to reduce artifacts in the composite image due to time-varying physical and/or optical variations of components in CFPA camera 10.

The lens assemblies 21-23 and CFPA board 100 are arranged in a housing 15, which mechanically maintains the arrangement of the elements of the camera and protects the camera from environmental sources of damage or interference. Board 100 includes a substrate 115 (e.g., but not limited to, PCB or ceramic substrate) and fourteen discrete FPA sensor modules 110a-110n, collectively “FPA sensor modules 110,” are mounted on a surface 105 of the PCB. Each of the FPA sensor modules 110 includes a pixelated array of light detector elements which receive incident light through a corresponding one of the lens assemblies 21-23 (collectively, “lens assemblies 20”) during operation of the system. An optical axis 21-23 of each lens assembly 21-23 is also shown. The optical axes 21-23 are parallel to each other within the angle of the overlapping edges between FPAs (e.g., about O(100) μrad or less).

Because an image field of each lens assembly 21-23 extends over an area that encompasses multiple sensor modules, each discrete sensor module receives a portion of the light imaged onto the CFPA board 100. During operation, each of the lens assemblies 20 receive incident light from a distant object (or scene containing multiple objects) and image the light onto the corresponding focal plane. The FPA sensor modules 110 converts the received light into signals containing information about the light intensity at each pixel.

The FPA sensor modules 110 are arranged in three sensor groups 120a, 120b, and 120c, collectively, “sensor groups 120.” Each sensor group 120a-c corresponds to one of the lens assemblies 21-23 such that the sensors in each group receive light imaged by their corresponding lens assembly.

In general, the FPA sensor modules 110 are sensitive to electromagnetic radiation in an operative range of wavelengths. Depending on the implementation, the operative wavelength range can include visible light, e.g., visible light of a specific color, infrared (IR) light, and/or ultraviolet (UV) light. In some non-limiting examples, the FPA sensor modules 110 are sensitive to a wavelength range that includes from about 0.35 μm to about 1.05 μm (e.g., about 0.35 μm to about 0.74 μm, about 0.40 μm to about 0.74 μm). In some examples the FPA sensor modules 110 are sensitive to IR light having wavelengths from about 0.8 μm to about 12 μm (e.g., about 0.9 μm to about 1.8 μm, about 0.9 μm to about 2.5 μm).

Some nonlimiting examples of the FPA sensor modules 110 include arrays of CMOS sensors, photodiodes, or photoconductive detectors. Each of the FPA sensor modules 110 have a resolution corresponding to the dimensions of the array of light detectors, commonly referred to as ‘pixels.’ The resolution of the FPA sensor modules 110 is such that when the signals received from the FPA sensor modules 110 are converted to images and subsequently merged into a mosaic image, the mosaic image resolution achieves a desired threshold. Some examples of resolution of the FPA sensor modules 110 include, but are not limited to, 1024×1024, 3072×2048 or even larger commercially-available arrays (e.g., 16,384×12,288, which represents the largest array presently known).

In general, each FPA sensor module produces an image of a small portion (e.g., about 20% or less, about 10% or less, such as about 5% to about 10%) of the overall field of view of the camera. The image processing subsystem 12 then constructs a larger, composite image of, e.g., the entire field of view or a scene area of interest encompassing images from more than one FPA sensor module, by appropriately arranging the image from each FPA sensor module relative to the other images. Such a composite image is a “mosaic” image. A nonlimiting example of a mosaic image 125 in a brick wall configuration constructed from images from each FPA sensor module 110 is shown in FIG. 1C. The FPA sensor modules 110 of each of the sensor groups 120 are arranged such that the portion of the focal plane imaged by each of FPA sensor modules 110 are interleaved to form the mosaic image representing the object plane. The signals received by the readout electronics from the FPA sensor modules 110 are converted into image data. Each of the FPA sensor modules 110 produces an associated image including a portion of the imaged light from the lens elements 20. For example, FPA sensor module 110a produces signals which is received by readout electronics to produce a corresponding image 110a′, FPA sensor module 110b produces a signal which is received by the readout electronics to produce image 110b′, etc. In this manner, each of the FPA sensor modules 110 produces signals which are converted into a corresponding one of images 110a′-110n′.

The imaging processing system interleaves the images 110a′-110n′ according to the arrangement of the FPA sensor modules 110 on the PCB 115 of FIGS. 1A and 1B. In general, the arrangement of each of the FPA sensor modules 110 within the respective sensor groups 120 is maintained within the composite, mosaic image 125. For example, sensor group 120a includes FPA sensor modules 110a, 110b, 110c, and 110d arranged in a diamond shape. Images 110a′-110d′ are arranged within the mosaic image 125 according to the same diamond shape. Similarly, the images 110e′-110n′ of sensor group 120b and sensor group 120c are arranged to correspond with the arrangement of the associated FPA sensor modules 110e-110n within their respective sensor groups 120b and 120c. The layout arranges the FPA sensor modules 110 such that the corresponding images 110a′-110n′ are arranged in a brick wall configuration when interleaved to form the mosaic image 125.

In the present example, each FPA sensor module is rectangular in shape and produces a corresponding rectangular image (of height H and width W). However, CFPAs may be implemented with other shapes of FPAs, such as square, hexagonal, or other polygon, etc.

Moreover, while the example CFPA camera described above includes a specific arrangement of FPA sensor modules, lens assemblies, and other components, in general, other arrangements are possible. For instance, while the CFPA camera 10 includes three lens assemblies, other arrangements can be used (e.g., but not limited to, one, two, or more than three lens assemblies). Additionally, each sensor group is depicted as including either four or five FPA sensors in FIGS. 1A and 1B. However, other numbers of sensors can be grouped (e.g., but not limited to, fewer than four, such as two or three, or more than five).

Furthermore, while images 110a′-110n′ in the composite image are depicted as having edges of adjacent images completely aligned, adjacent images in a composite projection overlap with one another as delineated in FIG. 1D for a subset of the images corresponding to the ROI shown in FIG. 1C. In FIG. 1D, the overlapping regions are shaded.

While the example described above includes a specific arrangement of FPA sensor modules, lens assemblies, and other components, in general, other arrangements are possible. For instance, while the CFPA camera 10 includes three lens assemblies, other arrangements can be used (e.g., but not limited to, one, two, or more than three lens assemblies). Moreover, each sensor group is depicted as including either four or five FPA sensors. However, other numbers of sensors can be grouped (e.g., but not limited to, fewer than four, such as two or three, or more than five).

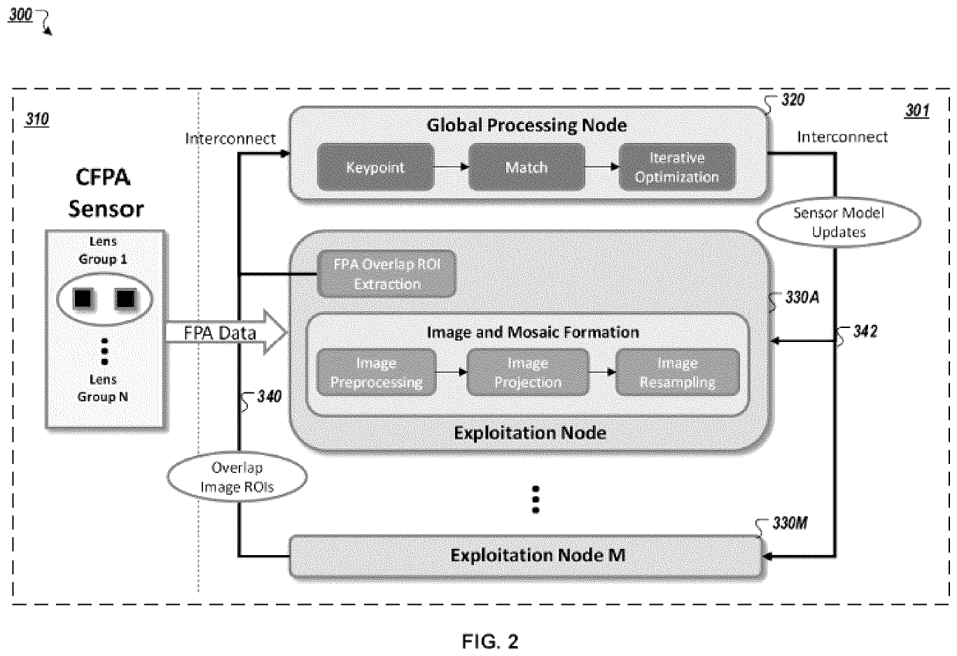

An exemplary image processing subsystem 301 for a CPFA imaging system 300 is delineated in FIG. 2. Imaging system 300 includes a CFPA camera 310 composed of N total lens groups that is in electrical communication with processing system 301, e.g., via cabling and/or wireless data transfer. An example CFPA camera is shown camera 10, described above. Image processing subsystem 301 is housed with or near CFPA sensor 310 and provide processing local to the platform in which the CFPA imaging system 300 is installed.

Image processing subsystem 301 is programmed to perform an in-situ, real-time calibration of camera 310 to generate updates to a sensor calibration model used to reduce misalignment of images from individual FPA sensor modules in a composite image.

Processing subsystem 301 includes a series of nodes including a global processing node 320 and M exploitation nodes 330A-330M. In some examples, each FPA sensor module has a corresponding exploitation node. The nodes are in communication with each other via interconnects 340 and 342, which facilitate communication of data between the exploitation nodes 330 and the global processing node 320. As delineated, interconnect 340 provides data from exploitation nodes 330 to global processing nodes 320 and interconnect 342 provides data from global processing node 320 to exploitation nodes 330. The global processing node 320 and exploitation nodes 330A-330M can be implemented using one or several processing units (e.g., central processing units (CPU) and/or graphical processing units (GPUs)). In some cases, each node is implemented using a separate processing unit. Alternatively, multiple nodes can be implemented using a single processing unit. In certain cases, a single node can be implemented using more than one processing unit.

In general, the CFPA imaging systems described herein have useful applications in many different areas. On the public safety front, they provide deterrent for crime, and tools for crime investigations and evidence gathering. The CFPA camera systems provide live coverage of huge areas to aid in rescue efforts in disaster situations, providing a rapid means of assessing damage to speed up the rebuilding process, monitoring very large areas including wildfires (e.g., >30,000 acres at once) to guide the firefighting efforts, find safe zones for those who are surrounded and facilitate prediction of fire evolution days in advance. The CFPA camera systems provide wide area persistent data needed for smart and safe cities, such as during riots and large crowd events. Additionally, the CFPA camera systems are useful for coastal monitoring, conservation, news coverage, and port and airport security.

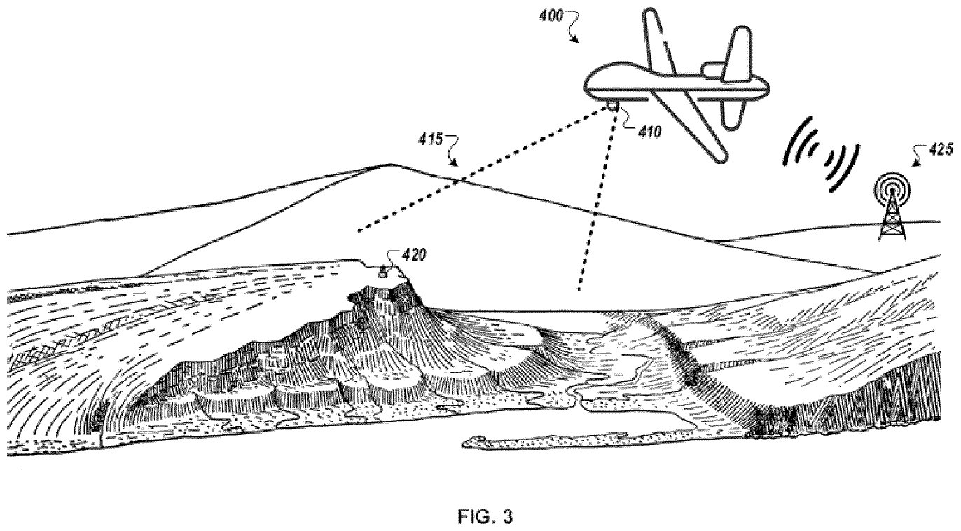

The CFPA imaging system disclosed herein can be used in an aerial vehicle, a satellite, or elevated observation platform. In certain examples, the devices and systems are used for wide area persistent motion imaging, described above. An example aerial observation system useful for wide area persistent motion imaging, specifically an unmanned aerial vehicle 400 (or “drone 400”), is shown in FIG. 3. Drone 400 includes an imaging system 410 for capturing imagery within a field of view (FOV) 415. A controller directs the imaging system 410 with a CFPA camera to image one or more targets, e.g., target 420, in response to commands received from a remote or local controller. Drone 400 also includes a communications module for wirelessly transmitting data from the imaging system 400 to a remote communications platform 425 and receiving control commands from a remote controller (e.g., the same or different from communications platform 425). Imaging system 410 can include an actuation module which mechanically reorients the CFPA camera to change the field of view and/or retain the same field of view as the drone moves. A controller onboard drone 400 can perform processing of image data acquired by imaging system 410 to generate, or facilitate remote generation of, images and/or video.

In addition to drones, exemplary observation systems can include manned aerial vehicles include airplanes and helicopters. Dirigibles can also be used. In some examples, observation systems can be mounted to a stationary observation platform, such as a tower.

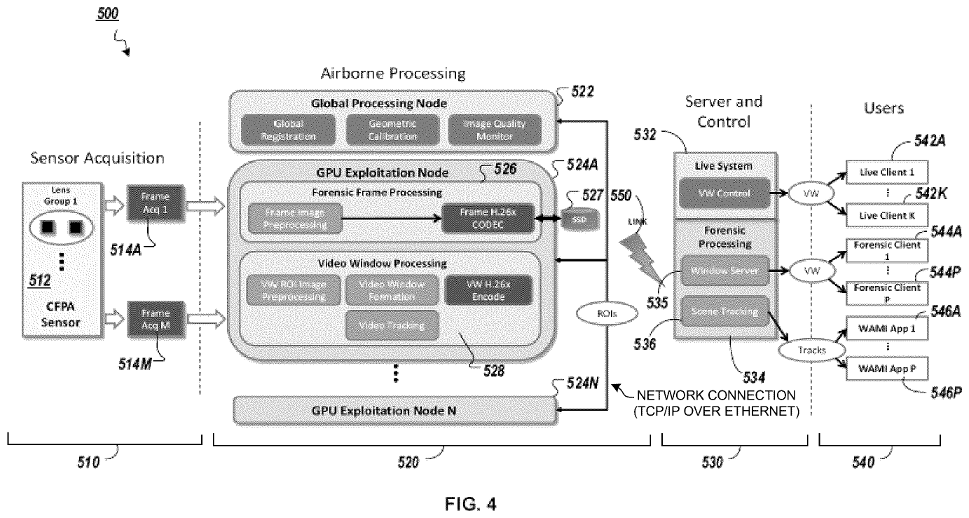

A system 500 for delivering image data including multiple live video streams from an airborne platform, such as a drone, to different users is delineated in FIG. 4. System 500 includes a CFPA camera 510 and an image processing subsystem 520 mounted in the airborne platform and a server system 530 at some remote location, e.g., a mobile or fixed land-based facility. The airborne platform and server system 530 are in communication over a wireless connection 550. Among other control signals, the airborne platform receives requests for live video feeds from the server system 530 and transmits image data in response to the requests over the wireless connection 550.

System 500 can support a variety of different users 540, or “clients”, of connected to server system 530 via a network, such as the internet. The users 540 include live clients 540A-540K, forensic clients 544A-544P, and WAMI application clients 546A-546P. Live clients 542A-542K are clients requesting live video feeds from the airborne platform. Each live client can request its own region of interest (ROI) of the scene being monitored by the airborne platform. As will be explained in more detail below, system 500 delivers live video feeds to each of the active live clients simultaneously. Forensic clients 544A-544P are clients requesting video or still footage of a ROI that was previously captured by the airborne platform. WAMI application clients 546A-546P are clients requesting video footage at requested locations that has not yet been stored. It represents the lowest latency product in the system, and is considered live video. This video may result from the mosaicking of ROIs from multiple FPAs—they should be created quickly to satisfy the live nature of the product.

Server system 530 includes a live system 532 and a forensic processing system 534. The live system 532 receives requests for video windows from live clients 542A-542K over the network, relays these requests wirelessly to the airborne platform. The live system 532 also receives image data prepared by the airborne platform in response to the live video requests and relays this image data to each of the live clients, providing each live client with their requested video window.

The forensic processing system 534 includes a window server module 535 and a scene tracking module 536. The window server module 535 delivers image data for the requested video windows to forensic clients 544A-544P while the scene tracking module delivers image data to the WAMI application clients 546A-546P.

A significant amount of image processing is performed on the airborne platform in order to manage delivery of the live video window feeds and other image data to the various clients subject to the bandwidth constraints of the wireless connection 550 and time-varying client load. CFPA camera 510 includes a CFPA sensor 512 and readout electronics including frame acquisition modules 514A-514M. CFPA sensor 512 includes one or more sensor groups (see prior discussion), each sensor group having a corresponding lens assembly. In some examples, the readout electronics include a separate frame acquisition module for each sensor group. In some cases, multiple sensor groups share a frame acquisition module. Alternatively, a single sensor group can be served by multiple frame acquisition modules. The frame acquisition modules 514A-514M receive image data (a time sequence of image frames) from each FPA sensor module of the sensor groups and deliver this image data to the image processing subsystem 520. Frame acquisition modules perform little, if any, data processing. They are primarily responsible for taking FPA output and formatting the data in a way suitable for ingesting into exploitation modes, e.g., using a standard protocol, such as MIPI.

The image processing subsystem 520 includes a global processing node 522 and multiple exploitation nodes 524A-524N. Image data are transported from the CFPA camera 510 to the image processing subsystem 520 over high data-rate interconnects (e.g., PCIe or GigE interconnects) to the global processing node 522 and exploitation nodes 524A-524N. An inter-node interconnect 523 provides a signal line connecting the global processing node 522 and the exploitation nodes 524A-524N, allowing image data movement needed to create the video streams. Typically, each node (global processing node 522 and exploitation nodes 524A-524N) includes a corresponding processor unit, such as a graphics processing unit (GPU), a field programmable gate array (FPGA), or an applicant specific integrated circuit (ASIC). The processing units can include system-on-chip (SoC) processing units.

The global processing node 522 provides global registration for the exploitation nodes, provides a geometric calibration (e.g., as described previously), and monitors image quality of the image data compiled by the exploitation nodes.

The exploitation nodes 524A-524N receive image data from the acquisition modules 514A-514M and each process the image data corresponding to a specific client request. Using multiple exploitation nodes means that image processing for multiple client requests can be processed in parallel. Each exploitation node 524A-524N includes a forensic frame processing module 526 and a video window process module 528. Forensic frame processing module 526 preprocesses each image frame and compresses the resulting image sequences using a codec (e.g., a commercially available standard codec, such as a H.264 codec). Depending on bandwidth demands, the forensic frame processing module 526 can store the compressed image sequences on a solid state drive 527 (or other non-volatile memory) or can transmit the data to the server system 530 via the wireless connection 550.

Video window processing module 528 processes image data according to live video feed requests from clients 542A-542K. This processing includes preprocessing image data from the frame acquisition modules according to the specific video window ROI assigned to the exploitation node. The module further serves to form the appropriate video window and steer the window (through the WAMI field of view) as the airborne platform moves relative to the scene. Forming the window includes mosaicking FPA ROIs into the requested data to cover the ground area of the user request (or angular direction for tower, or fixed-structure-mounted imagery). Steering the window can include recentering the window in the WAMI field of view to maintain its center at a fixed location or to follow an object based on an automated video object tracker. The video window processing module also compresses the resulting video image data before sending the compressed data to the server system 530 via the wireless connection 550.

The proposed approach also relates user requests to explicit FPA ROIs via a geometric sensor model and accompanying system position and orientation data. Window requests are specified as resolution (e.g., but not limited to, ground distance) and window size (e.g., but not limited to, in pixels), area coverage and window size (e.g., but not limited to, in pixels) in aerial cases, or view-angle and window size (e.g., but not limited to, in pixels) in fixed infrastructure cases. The bounds of the window, when projected through the sensor, define the ROIs required to cover the request.

Within the processor, data interconnect traffic is reduced by selecting only the ROIs needed to fulfill the request. This contrasts with traditional approaches which create full scene mosaics from which user requests are extracted. This can be wasteful when the user requests typically amount to <10% of the data (e.g., 50 users desiring 1920×1080 pixels is 5% of a 2 GPixel sensor). By applying a geometric sensor model, ROIs needed to cover the user requests can be extracted and used to form a video window without creating a full scene mosaic. This approach reduces the internal interconnect traffic and computation requirements, e.g., by about 50% or more, such as up to about 90-95%. In the discussion above, 50 users can be a demanding load for a wireless link and this number of users is consistent with conventional military systems and can exceed the number of users of a conventional commercial system.

The use of ROIs to form windows can also allow for varying types of video window projections. Typical approaches use orthorectified images which can degrade the image by projecting from an elevation model, i.e., the video window is extracted from a full scene mosaic which has been projected from another data source. Alternatively, in certain examples, video windows are created using ROIs or creating video from alternative projections (e.g., but not limited to, cylindrical projections used in fixed tower systems) that may not require additional data sources (e.g., elevation model used in orthorectified video).

In some examples, the video window processing module 528 resamples the image data (e.g., downsamples the image data). For example, in instances where many simultaneous live video requests places significant demand on the bandwidth constraints of the system, e.g., at wireless connection 550, one or more of the exploitation nodes can downsample the video image data to ease bandwidth demand for that exploitation node.

In general, the video window processing module 528 of each exploitation node can perform a variety of computations and processes to encode video streams suitable for the assigned video window request and the bandwidth of the system available to the video stream. These computations and processes can include, e.g., but not limited to, non-uniformity correction, video stream region of interest (ROI) selection and distribution, color interpolation and transformation (on ROIs), contrast and imagery enhancement (on ROIs), geometric video image formation (on video frames), and/or jitter stabilization (on video frames).

The image processing subsystem can minimize the image data processing useful for creating the end-user (i.e., client) video view. Independent video streams are hosted across exploitation nodes, and the hosting distribution can be independent of the mapping of sensor input to exploitation node. Mapping video streams to exploitation nodes independently of the acquisition input (or independent of geographic ground region) can permit a load balancing based on user demand. The number of data degradations can be reduced by performing the image processing steps on one exploitation node. So, for example, multiple image filters can be concatenated in a single filter thus reducing degradation due to resampling.

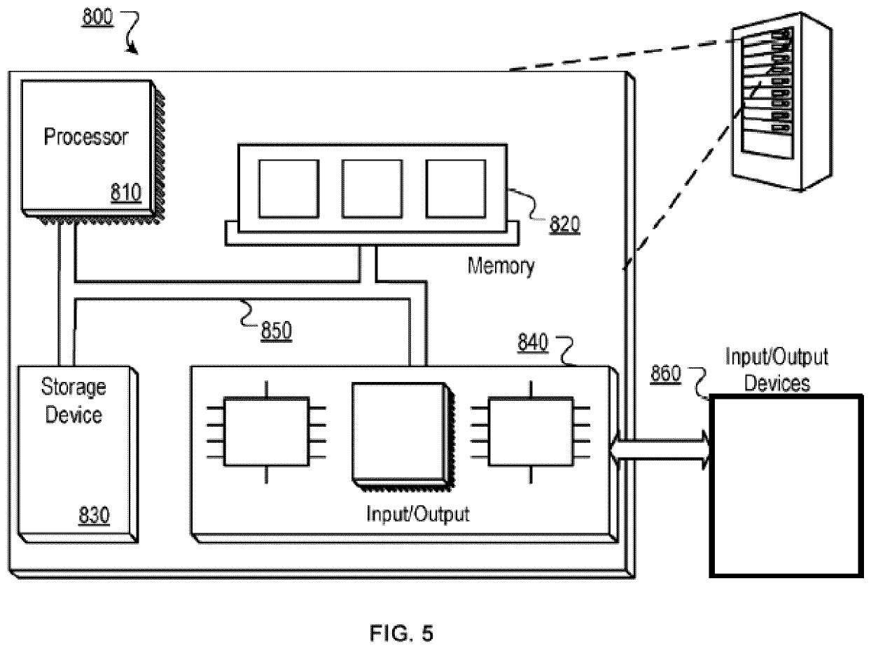

A block diagram of an exemplary computer system 800 that can be used to perform operations described previously is delineated in FIG. 5. Computer system 800 can be used or adapted for use as the image processing subsystem 301 and/or 520. The system 800 includes a processor 810, a memory 820, a storage device 830, and an input/output device 840. Each of the components 810, 820, 830, and 840 are interconnected, for example, using a system bus 850. The processor 810 processes instructions for execution within the system 800. In some implementations, the processor 810 is a single-threaded processor. Alternatively, the processor 810 can be a multi-threaded processor. The processor 810 processes instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 provides mass storage for the system 800. In one implementation, the storage device 830 is a computer-readable medium. In various different implementations, the storage device 830 includes, for example, a hard disk device, an optical disk device, a storage device that is shared over a network by multiple computing devices (e.g., but not limited to, a cloud storage device), or some other large capacity storage device.

The input/output device 840 provides input/output operations for the system 800. In some examples, the input/output device 840 includes one or more network interface devices, e.g., but not limited, an Ethernet card, a serial communication device, e.g., but not limited to, an RS-232 port, and/or a wireless interface device, e.g., but not limited to, and 802.11 card. In certain implementations, the input/output device 840 includes driver devices configured to receive input data and send output data to other input/output devices, e.g., but not limited to, a keyboard, keypad and display devices 860. Other implementations, however, can also be used, such as, but not limited to, mobile computing devices, mobile communication devices, and set-top box client devices.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., but not limited to, a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., but not limited to, an FPGA or an ASIC. The apparatus can optionally include, in addition to hardware, code that creates an execution environment for computer programs, e.g., code that constitutes processor firmware, a protocol stack, a database management system, an operating system, or a combination of one or more of them.

A “computer program,” which may also be referred to or described as a “program,” “software,” “software application,” “app,” “module,” “software module,” “script,” or “code”, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., but not limited to, one or more scripts stored in a markup language document, in a single file dedicated to the program in question, or in multiple coordinated files, e.g., but not limited to, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine is implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., but not limited to, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit receives instructions and data from a read-only memory or a random access memory or both. The elements of a computer are a central processing unit for performing or executing instructions and one or more memory devices for storing instructions and data. The central processing unit and the memory can be supplemented by, or incorporated in, special purpose logic circuitry. In some cases, a computer also includes, or can be operatively coupled to receive data from or transfer data to, or both, one or more mass storage devices for storing data, e.g., but not limited to, magnetic, magneto-optical disks, or optical disks. However, a computer need not have such devices. Moreover, a computer can be embedded in another device, e.g., but not limited to, a mobile telephone, a personal digital assistant (PDA), a mobile audio or video player, a game console, a Global Positioning System (GPS) receiver, or a portable storage device, e.g., but not limited to, a universal serial bus (USB) flash drive, to name just a few.

Computer-readable media suitable for storing computer program instructions and data include all forms of non-volatile memory, media and memory devices, including by way of example semiconductor memory devices, e.g., but not limited to, EPROM, EEPROM, and flash memory devices; magnetic disks, e.g., internal hard disks or removable disks; magneto-optical disks; and CD-ROM and DVD-ROM disks.

To provide for interaction with a user, examples can be implemented on a computer having a display device, e.g., but not limited to, a LCD (liquid crystal display) monitor or light emitting diode (LED) monitor, for displaying information to the user and a keyboard and a pointing device, e.g., but not limited to, a mouse or a trackball, by which the user provides input to the computer. Other kinds of devices can be used to provide for interaction with a user as well; for example, feedback provided to the user can be any form of sensory feedback, e.g., but not limited to, visual feedback, auditory feedback, or tactile feedback; and input from the user can be received in any form, including acoustic, speech, or tactile input.

In accordance with one embodiment of a UAV imaging system, the system includes number of image sensors. For each image sensor there is a corresponding GPU (graphics processing unit). These GPUs may be referred to as the exploitation GPUs. There is a one-to-one relationship between image sensors and exploitation GPUs. Each exploitation GPU receives image information in a one-to-one fashion from a corresponding one of the image sensors. In addition to the exploitation GPUs, there is a special GPU (Global Processing Node GPU) that is responsible for maintaining and updating the geometric sensor calibration model. To take advantage of economies of scale and benefits of mass production and standardization and flexibility of graphics processor platforms, and to take advantage of the existence of known programming interfaces of grapthic processor platforms, the GPUs of the UAV imaging system are identical mass-produced GPUs such as identical instances of the Jetson Xavier NX GPU module available from NVIDIA of Santa Clara, California. The exploitation GPUs and the special GPU intercommunicate with each other across a LAN network, for example using TCP/IP operating over Ethernet. Each GPU has a network port such as an RJ-45 port. This networked architecture is advantageous as compared to an earlier UAV imaging system architecture in that the nodes are GPUs as compared to FPGAs, and in that the nodes intercommunicate with each other using standard networking as compared to point-to-point fiber ring links between FPGAs. In a first step, a user on the ground wirelessly communicates a live video window request up to the UAV. This live video window request is received by a wireless communications module. The wireless communications module has a network port and can communicate across the network with the GPUs. The communication is sent from the communications module to one of the exploitation node GPUs. Successive such incoming live video window requests are handled by different ones of the exploitation node GPUs so as to provide an amount of load balancing for the processing necessary for handling incoming video window requests. In the presently described example, the incoming live video window request is handled (is “hosted”) by a first of the exploitation node GPUs referred to here as GPU #1. GPU #1 is also called the “host” GPU of the window. There are nine exploitation GPUs referred to as GPU #1 thru GPU #9. The special GPU is referred to as GPU #10. In response to receiving the live video window request, GPU #1 sends a request message to the special GPU #10 for a model update of the geometric sensor calibration model. GPU #10 generates an update of the model, and sends updated model information back to GPU #1. The messages are communicated vai the network. The sensors and other components of the overall imaging system can move with respect to one other, due for example to temperature changes, or mechanical impacts and vibrations, or pressure changes, or for other reasons. It is therefore important that a current version of the geometric sensor calibration model is used. The updated model information includes, for each sensor, a separate set of information values. The updated model information may, for example, includes for each sensor, a pixel size value, camera focal plane rows and columns, a value indicating the number of cameras, a value indicating the number of sensors in the system, distance and angle values for each sensor relative to a reference point, a focal length value for each lens, lens distortion parameters, spatial alignment coefficients, sensor pointing and navigation geometry values, ground terrain and geographic parameters, zoom levels for optimal source buffer, and a timestamp (an indication of the time when the model update occurred) or other model update identifier. The GPU #1 receives the updated model information from GPU #10 via the network, and then uses the updated model information to determine one or more focal plane array (FPA) regions of interest (ROIs) sufficient to fulfill the request by using request parameters and a geometric sensor model generate ROI requests (Region Of Interest). Each of the generated ROI requests is then communicated via the network to, and is addressed to, another one of the the exploitation GPUs. An ROI request includes information such as an ROI request identifier number, a model update timestamp (timestamp of the model update) value, a frame number, pixel coordinates that define a rectangle of pixels, and a sensor number, and an identifier of the GPU that is to respond to the ROI request. Each such addressed GPU returns its response to the ROI request directed to it, and these ROI request responses and commuinicated across the network back to the host GPU #1. The host GPU #1 uses the image data of the incoming ROI request responses, as well as other information local to GPU #1, to stitch together the image data. Only that image data necessary to satisfy the live video window request is communicated across the network, so that the vast amout of other image data for the entire composition focal plane array is not communicated across the network. The stitched together image data is then forwarded from the host GPU #1 across the network to the communications module, and from the communications module is wirelessly transmitted from the UAV back to the user on the ground in fullfilment of the original live video window request.

To create a mosaic image, the system transfers the image frames associated with the ROIs of the selected ground region to the exploitation node to which it is mapped. The present method generalizes to minimize data transfer to the ROIs needed for viewing by filtering ROIs that do not contributed to creation of the whole image. This generality characteristic also creates video frames with arbitrary projections which include those that can be recoverable (e.g., 2D projection from a plane). The present method and system generalize the video creation processor distribution based on user request to balance the computational load based on, e.g., total user requirement, which avoids geographically-restricted scaling issues.

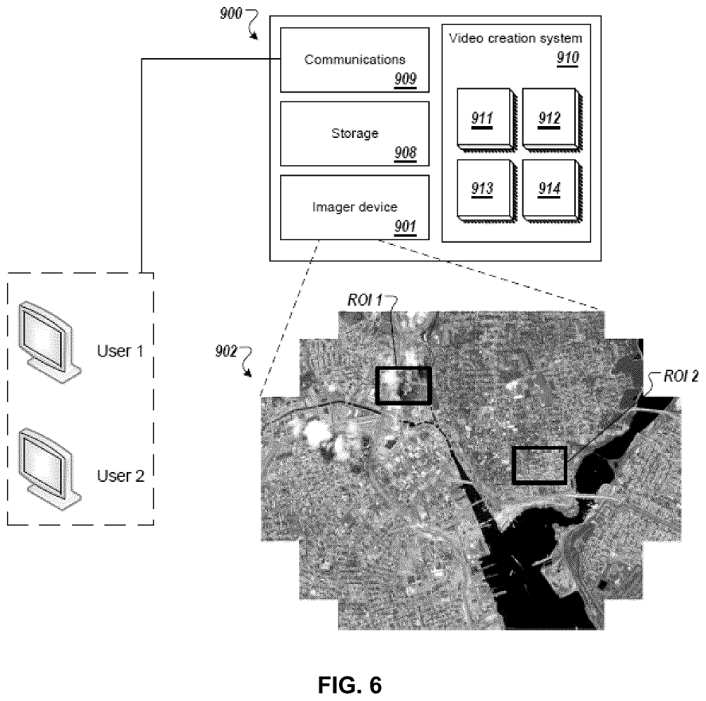

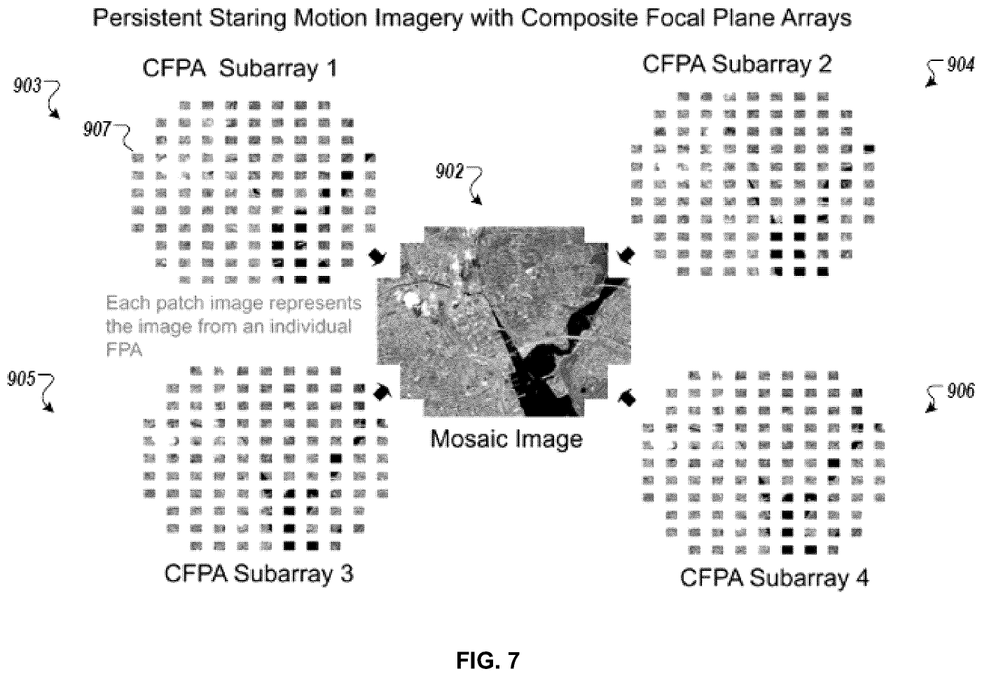

A CFPA video system 900 for providing a video stream to a user is shown in FIG. 6. The CFPA video system 900 includes an imager device 901 which is a wide-field imager including at least one CFP imaging array (CFPA). Each CFPA includes an array of imaging multi-pixel image sensor devices arranged behind an imaging optical element, e.g., one or more lenses. In some examples, the CFPA imaging arrays are arranged behind a common, e.g., one, imaging optical element. Each image sensor device of the array is configured to image a portion of the focal plane of the imaging optical element, e.g., a common focal plane. The combined focal plane portions of the image sensor devices correspond to a contiguous area of the focal plane. The portions of the common focal plane of the individual images overlaps by a small amount with the focal plane of the neighboring images received by neighboring imaging sensors. In some examples, the overlap is less than 10% of the total imaged area of the individual sensors e.g., less than 5%, less than 1%, less than 0.5%, or less than 0.25%. A mosaic image is generated using the individual images as a portion of the mosaic image, e.g., the mosaic image is a composite of the various individual images. As such, the mosaic image is formed having the per pixel resolution of the individual images, but larger overall focal plane area (e.g., between 50% and 99% of the total focal plane area of the summed individual images). In some examples, the imaging focal plane of multiple CFPA cameras are aligned such that images taken by the imaging sensors of the CFPA can be composited to form a mosaic image of a contiguous geographic region. For example, a composite mosaic image 902 formed from four composite focal plane array (CFPA) images 903, 904, 905, and 906 is shown in FIG. 7. Each CFPA image 903, 904, 905, and 906 was acquired by four interleaved focal planes each consisting of ninety-two 5 megapixel (Mp) individual imaging chips 907. This results in the 1.8 gigapixel (Gp) mosaic image 902.

In the example of FIG. 7, the focal planes of each neighboring imaging chip 907 overlap on all sides having a neighbour by an amount of <0.25% of the length of the rows and columns of the sensors which collect each imaging chip 907. These overlaps are used to equalize, e.g., normalize, the responses of the imagers. The overlaps are used with row number, column number, and 2-D averaged intensities to produce image smoothing for the final mosaic image 902.

The imager device 901 is arranged such that the focal plane covers a contiguous geographic region (e.g., a surface area on the ground, e.g., a surface of Earth) and the imager device 901 images a portion of the contiguous geographic region to each of the image sensor devices. In some examples, the contiguous geographic region covers an area in a range from about 1 km2 to about 100,000 km2 (e.g., from about 10 km2 to about 100,000 km2, from about 100 km2 to about 100,000 km2, from about 1,000 km2 to about 100,000 km2, from about 10,000 km2 to about 100,000 km2, from about 10 km2 to about 10,000 km2, from about 10 km2 to about 1,000 km2, from about 100 km2 to about 1,000 km2, or from about 1,000 km2 to about 10,000 km2). In some examples, the CFPA video system 900 includes more than one imager device 901, e.g., two or more. A CFPA video system 900 including more than one imager device 901 may image different geographic regions for each imager device 901.

The CFPA video system 900 receives the mosaic image 902 from the imager device 901 and stores the mosaic image 902 on a storage device 908, e.g., a local storage device 908. The CFPA video system 900 commands the imager device 901 to generate additional mosaic images 902 of the contiguous geographic region and stores them on the storage device 908.

In some examples, the CFPA video system 900, or the imager device 901, compresses the mosaic image 902. Compressing the mosaic image reduces the data size of the mosaic image which reduces transfer data rate between components of the CFPA video system 900, reduces storage space in the storage device 908, and reduces the time to perform an image resampling process for video stream creation as discussed further herein. Compressing the mosaic image 902 in a lossless format allows the original data to be reconstructed from the compressed data with significantly reduced loss of information.

The CFPA video system 900 receives a series, e.g., a temporal sequence, or a temporal series, of mosaic images, such as multiple of mosaic image 902. The series of mosaic images correspond to a series of images of the contiguous geographic region imaged by the imager device 901. The CFPA video system 900 compresses, stores, or both, the series of mosaic images.

The CFPA video system 900 includes a communications device 909 for sending and receiving data over a communications network, e.g., a wireless network (Wi-Fi, telecoms), or a wired network. The communications device 909 receives video stream requests from users (e.g., requestors).

Two users, User 1 and User 2, provide video stream requests to the communications device 909 in FIG. 6. The video stream requests include at least a region of interest (ROI) and one or more video stream parameters. ROIs included in a video stream request correspond to an unbroken portion of the contiguous geographic region imaged by the imager device 901, e.g., an unbroken portion of the mosaic image 902. The ROI request may include one more object of interest within the focal plane boundaries of the ROI. Examples of objects of interest include one or more vehicles, one or more persons, one or more animals, one or more buildings, and one or more geographic landmarks. The mosaic image 902 encompasses two ROIs, ROI 1 and ROI 2, included in the requests from User 1 and User 2 respectively.

The video stream request may include a request for a fixed ROI in which the video stream is maintained at fixed locations within a fixed portion of the contiguous geographic region. The video stream may be moved through the contiguous geographic region to track the object of interest in examples in which the video request includes an object of interest. In such examples, the video stream is steered through the contiguous geographic region to facilitate maintaining the object of interest within the video stream.

The video stream parameters included in the video stream request include parameters which define the video stream to be provided to the requestor from the CFPA video system 900. Examples of video stream parameters include, but are not limited to, a resolution (e.g., 240p, 480p, 720p, 1080p, 1440p, or 2160p), a frame rate (e.g., 24 frames per second (fps), 30 fps, or 60 fps), a video codec (e.g., MPEG-2, MPEG-4, or H.264), or a data rate (e.g., a bit rate, in a range from about 40 kbps to about 5,000 kbps).

In some examples, the CFPA video system 900 limits the bitrate for each video stream by determining the maximum communications data rate that the communications device 909 is capable of providing to a number of users and distributing the maximum data rate between the users. The CFPA video system 900 may divide the maximum data rate between the users evenly, or according to a non-uniform scheme (e.g., 70% of the maximum data rate to User 1, and 30% of the maximum data rate to User 2).

The communications device 909 receives the video stream requests from requestors and provides the video stream requests to the CFPA video system 900. The CFPA video system 900 determines the number of video stream requests and provides the requests to a video creation system 910. The CFPA video system 900 includes a video creation system 910 having exploitation nodes (e.g., processor nodes), examples of which include graphics processing units (GPUs), field-programmable gate arrays (FPGA), application-specific integrated circuits (ASICs), or system-on-chips (SoCs). In general, one node corresponds to one processor device, e.g., one GPU, FPGA, or SoC, though in some implementations, the node may include multiple individual processor devices. The video creation system 910 depicts exploitation nodes 911-914 though more or less may be included in the system 910.

The exploitation nodes 911-914 are interconnected, e.g., locally, or over a wired or wireless network, to facilitate image data movement at data rates sufficient useful to create the requested video streams (e.g.,). Data movement between the exploitation nodes 911-914 facilitates video stream steering which corrects for unintended relative motion of the ROI with respect to the mosaic image, e.g., motion of the geographic area within the ROI relative the mosaic image 902, due to the platform motion, the object motion, or both.

The video creation system 910 receives the video stream requests and determines the portions of the stored mosaic image 902 corresponding to the ROIs encoded in the video stream requests. The video creation system 910 determines the portion of the mosaic image 902 to be resampled corresponding to the requested ROIs.

The video creation system 910 resamples the portion of the mosaic image 100 corresponding to the requested ROIs to meet the video stream parameters within the video stream requests. In general and without wishing to be bound by theory, resampling is the process of altering an images resolution by either adding or removing extra pixels. Types of image resampling include upsampling, downsampling, and interpolation. The resampled portions of the mosaic images are used to create video frames on the exploitation nodes for each video stream request.

CFPA imagery data, e.g., the mosaic images, which includes multiple image frames are transported over high data rate interconnects (e.g., peripheral component interconnect express (PCIe) or GigE) to exploitation nodes 911-914. The exploitation nodes 911-914 perform one or more computations on the CFPA imagery data to produce a video stream for each of the video stream requests. The video creation system 910 receives the CFPA imagery data, resample image frames from the mosaic images to create video frames, and encode the video frames into a video stream in the CFPA video system 900. The computations include, but are not limited to: Non-uniformity correction, e.g., adjusting for drift of the imager device 901 that occurs as the scene and environment change and the CFPA video system 900 moves through a space; Video stream ROI selection and distribution; Color value interpolation and color space transformation within the ROIs, e.g., determining one or more color values that reside between any two given color values in a color space, or transformation between a first color space and a second. Examples of color spaces used in video streams include 8-bit or 10-bit RGB, YUV, or YCbCr.; Contrast and imagery enhancement on determined ROIs; Geometric video image formation on video frames; and Jitter stabilization on video frames, e.g., shifting one or more frames of the video stream to counteract error introduced by sensor motion of the imager device 901.

CFPA image data processing is restricted to the portions of the mosaic images which correspond to the ROIs to create the video frames for the end-user video stream. Restricting the processing to the ROI portions reduces the computational cost, e.g., time to complete the resampling and production of the video streams, compared to processing of the entire mosaic image 902. Independent video streams are hosted across exploitation nodes, and the hosting distribution is independent of the mapping of sensor input to exploitation node. Mapping video streams to exploitation nodes independently of the acquisition input, or independent of geographic ground region, permits a load balancing based on demand, e.g., a controller demand or a user demand.

The video creation system 910 provides the video streams to the CFPA video system 900 which provides the video streams to the communications device 909. The communications device 909 transmits the video stream to the corresponding requestors, e.g., video stream of ROI 1 to User 1 and video stream of ROI 2 to User 2.

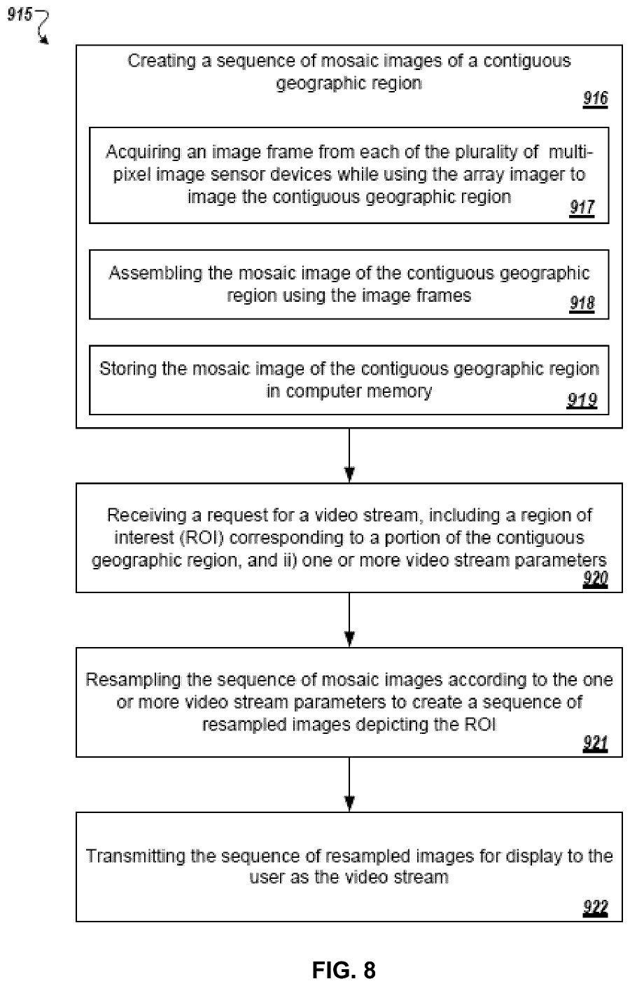

The disclosure provides a method 915 for providing a video stream to a user shown in FIG. 8. The method 915 includes creating a sequence of mosaic images of a contiguous geographic region (step 916). For each mosaic image of the temporal sequence, the method 915 includes acquiring an image frame from each multi-pixel image sensor devices while the imager device 901 images the contiguous geographic region (step 917). The imager device 901 provides an image frame from each of the sensors to the CFPA video system 900. Each image frame corresponds with a portion of the contiguous geographic region.

The method 915 includes assembling the mosaic image using the image frames (step 918). The CFPA video system 900 receives the image frames from the imager device 901. In some examples, the CFPA video system 900 compresses the mosaic image, such as compressing the mosaic image into a lossless format. The CFPA video system 900 stores the mosaic image of the contiguous geographic region in the storage device 908, e.g., computer memory (step 919). The CFPA video system 900 then assembles the stored mosaic images into a sequence, e.g., a temporal sequence, of mosaic images of a contiguous geographic region.

The method 915 includes receiving a video stream request from a user (step 920). The video stream request includes an ROI corresponding to a portion of the contiguous geographic region and one or more video stream parameters. The video stream request can include one or more object of interests within the ROI. The objects of interest, video stream parameters, or ROIs, can be any described herein.

The method 915 includes resampling the temporal sequence of mosaic images according to the one or more video stream parameters to create a sequence of resampled images depicting the ROI (step 921). The CFPA video system 900 receives the video stream request including the ROI. The CFPA video system 900 resamples the image data corresponding to the ROI from the sequence of mosaic images.

The CFPA video system 900 assembles the resampled image data corresponding to the ROI into a sequence of resampled images depicting the ROI.

The method 915 includes transmitting the sequence of resampled images for display to the user as the video stream (step 922). The CFPA video system 900 transmits, using the communications device 909, the video stream to the requesting user.

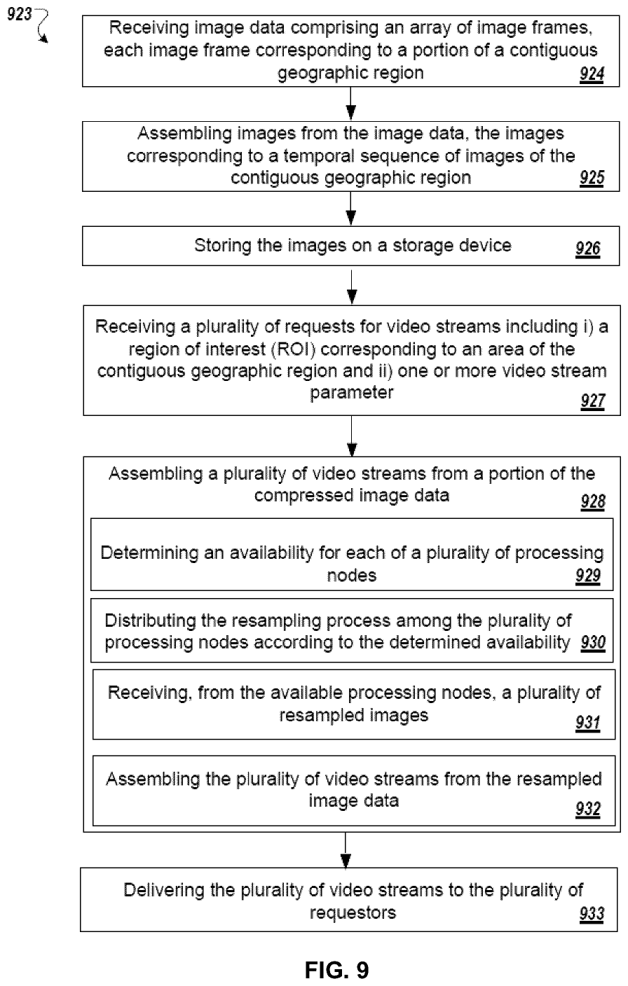

The disclosure provides a method 923 for processing image data shown in FIG. 9. The method includes receiving image data including an array of image frames, each image frame corresponding to a portion of a contiguous geographic region (step 924). The CFPA video system 900 acquires an image frame from each multi-pixel image sensor devices while the imager device 901 images the contiguous geographic region. Each image frame corresponds with a portion of the contiguous geographic region.

The method 923 includes assembling images from the image data, the images corresponding a temporal sequence of images of the contiguous geographic region (step 925). For each mosaic image of the sequence, the CFPA video system 900 assembles the mosaic image 902 using the image frames. The CFPA video system 900 can compress the mosaic image, such as compress the mosaic image into a lossless format. The CFPA video system 900 then assembles the mosaic images into a temporal series of mosaic images of a contiguous geographic region.

The method 923 includes storing the images on a storage device (step 926). The CFPA video system 900 stores the temporal series of mosaic images of the contiguous geographic region in the storage device 908, e.g., computer memory.

The method 923 includes receiving a plurality of requests for video streams including i) a region of interest (ROI) corresponding to an area of the contiguous geographic region and ii) one or more video stream parameter (step 927). The video stream request can include one or more object of interests within the ROI. The objects of interest, video stream parameters, or ROIs, can be any described herein. For each video stream request, the CFPA video system 900 determines a resampling recipe based on the objects of interest, video stream parameters, or ROI within the video stream request.

The method 923 includes assembling a plurality of video streams from a portion of the compressed image data (step 928). The video creation system 900 includes processing nodes described herein. The method 923 includes determining an availability (e.g., an availability value) for each of a plurality of processing nodes (step 929). In an example, node availability is determined by the ratio between the time to resample on an unloaded node divided by the time to resample on a loaded node. The CFPA video system 900 queries the video creation system 910 for an availability value for each of the processing nodes. The video creation system 910 provides an availability value for each of the processing nodes (e.g., such as exploitation nodes 911-914) to the system 900.

The CFPA video system 900 receives the availability values for the plurality of processing nodes. The method 923 includes distributing the resampling process among the plurality of processing nodes according to the determined availability (step 930). The CFPA video system 900 divides the image frames to be reprocessed among the processing nodes according to the provided availability values. Processing nodes for which the video creation system 910 determined an availability value indicating high availability receive a larger portion of the resampling process than processing nodes which the video creation system 910 determined have a low availability. The video creation system 910 provides to the processing nodes an availability value indicating high availability receive one or more image frames to be resampled from the plurality of image frames.

The method 923 includes receiving, from the available processing nodes, a plurality of resampled images (step 931). The video creation system 910 receives the resampled images from the exploitation nodes 911-914.

The method 923 includes assembling the plurality of video streams from the resampled image data (step 932). The video creation system 910 assembles the requested video streams for each requesting user. The video creation system 910 provides the video streams to the CFPA video system 900.

The method 923 includes delivering the plurality of video streams to the plurality of requestors (step 933). The CFPA video system 900 provides the video streams to the communications device 909. The communications device 909 transmits the video streams to the requestors (e.g., the requesting users).

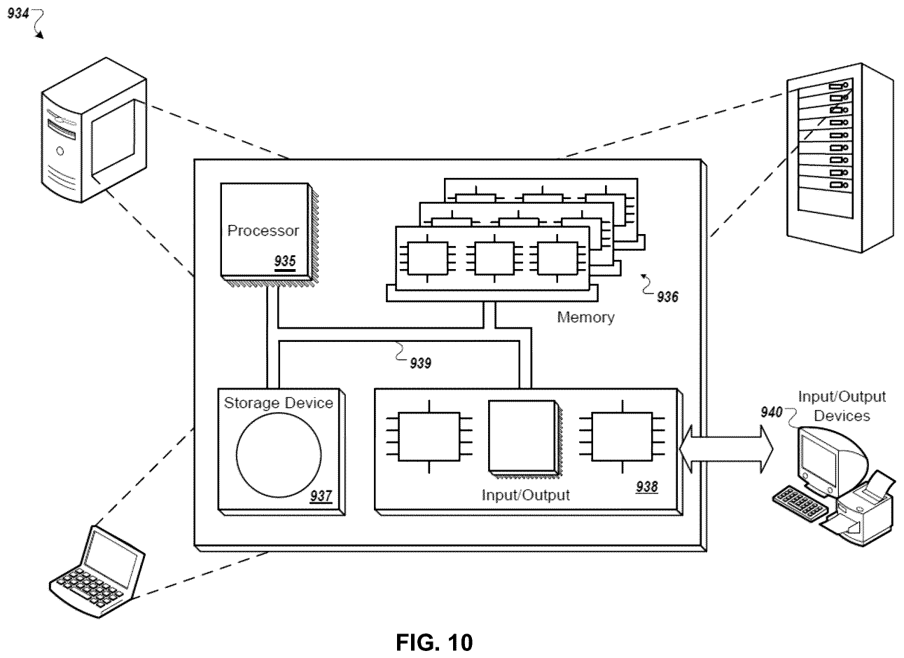

A block diagram of an exemplary computer system 934 is shown in FIG. 10. For example, referring to FIG. 6, the CFPA video system 900 could be an example of the system 934 described here, as could a computer system used by any of the users who access resources of the CFPA video system 900. The system 934 includes a processor 935, a memory 936, a storage device 937, and one or more input/output interface devices 938. Each of the components 935, 936, 937, and 938 can be interconnected, for example, using a system bus 939.

The processor 935 is capable of processing instructions for execution within the system 934. The term “execution” as used here refers to a technique in which program code causes a processor to carry out one or more processor instructions. In some implementations, the processor 935 is a single-threaded processor. In some implementations, the processor 935 is a multi-threaded processor. The processor 935 is capable of processing instructions stored in the memory 936 or on the storage device 937. The processor 935 may execute operations such as creating video streams from resampled portions of mosaic image data.

The memory 936 stores information within the system 934. In some implementations, the memory 936 is a computer-readable medium. In some implementations, the memory 936 is a volatile memory unit. In some implementations, the memory 936 is a non-volatile memory unit.

The storage device 937 is capable of providing mass storage for the system 934. In some implementations, the storage device 937 is a non-transitory computer-readable medium. In various different implementations, the storage device 937 can include, for example, a hard disk device, an optical disk device, a solid-state drive, a flash drive, magnetic tape, or some other large capacity storage device. In some implementations, the storage device 937 may be a cloud storage device, e.g., a logical storage device including one or more physical storage devices distributed on a network and accessed using a network.

The input/output interface devices 938 provide input/output operations for the system 934. In some implementations, the input/output interface devices 938 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, etc. A network interface device allows the system 934 to communicate, for example, transmit and receive data with the communications device 909 such as requested video streams as shown in FIG. 6. In some implementations, the input/output device can include driver devices configured to receive input data and send output data to other input/output devices, e.g., keyboard, printer and display devices 940. In some implementations, mobile computing devices, mobile communication devices, and other devices can be used.

In some examples, the system 934 is contained within a single integrated circuit package. A system 934 of this kind, in which both a processor 935 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 938.

Although an example processing system has been described in FIG. 10, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. The components of the system can be interconnected by any form or medium of digital data communication, e.g., a communication network such as the network over which the communications device 909 communicates as shown in FIG. 6. Examples of communication networks include a local area network (“LAN”) and a wide area network (“WAN”), e.g., the Internet.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. Although various features of the approach of the present disclosure have been presented separately (e.g., in separate figures), the skilled person will understand that, unless they are presented as mutually exclusive, they may each be combined with any other feature or combination of features of the present disclosure. While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple examples separately or in any suitable subcombination. Those skilled in the art will recognize, or be able to ascertain, using no more than routine experimentation, numerous equivalents to the specific examples described specifically herein. Such equivalents are intended to be encompassed in the scope of the following claims.

What is claimed is:

1. A system, comprising:
a composite focal plane array (CFPA) imaging system installed on an airborne platform, the CFPA imaging system comprising:
a CFPA camera comprising a plurality of focal plane array (FPA) sensor modules, the CFPA camera comprising optics to image a scene in a field of view onto the FPA sensor modules such that each FPA sensor module acquires an image of a different portion of the scene;
an image processing subsystem comprising a plurality of nodes in communication with the global client node via one or more interconnects, each node being programmed to process image data from the CFPA camera according to a video window corresponding to a scene area of interest; and
a server system remote from the airborne platform, the server system being in communication with the airborne platform via a wireless connection, the server system being configured to receive live video requests from one or more clients over a network and deliver, to the one or more clients over the network, a live video feed of the region of interest of the scene selected by the client.

2. The system of claim 1, wherein the airborne platform is an unmanned aerial vehicle.

3. The system of claim 1, wherein the FPA sensor modules of the CFPA camera are arranged in a plurality of sensor groups and the optics of the CFPA camera comprise a plurality of lens assemblies, each lens assembly corresponding to one of the sensor groups.

4. The system of claim 3, wherein the CFPA camera comprises image readout electronics configured to receive image data from each of the FPA sensor modules and transmit the image data to the image processing subsystem.

5. The system of claim 1, wherein the image processing subsystem is programmed to project and resample images for the one or more live video feeds according to a total number of simultaneous live video feeds and a bandwidth of the wireless connection between the airborne platform and the server system.

6. The system of claim 1, wherein the plurality of nodes comprises multiple exploitation nodes each comprising a video window processing module programed to process image data to provide processed image data according to one of the live video requests.

7. The system of claim 6, wherein the image data processing by the video window processing module comprises mosaicking regions-of-interest of FPAs corresponding to a video window according to one of the live video requests.

8. The system of claim 1, wherein the plurality of nodes comprises multiple exploitation nodes each programmed to project and resample imagery corresponding to the video window assigned to the exploitation node.

9. The system of claim 1, wherein the image processing subsystem comprises a plurality of processor units, each of the plurality of nodes comprising a corresponding one of the processor units.

10. The system of claim 9, wherein each processor unit comprises a graphics processing unit (GPU).

11. The system of claim 9, wherein each processor unit comprises a field programmable gate array (FPGA) or an application specific integrated circuit (ASIC).

12. A method for simultaneously providing multiple live video windows to different clients from an airborne platform, the method comprising:
receiving, at the airborne platform from a remote server via a wireless transmission, requests for the multiple live video windows from different clients;
acquiring a sequence of image frames using a composite focal plane array (CFPA) imaging system of a scene installed on the airborne platform, the scene including scene areas of interest corresponding to the video windows requested;
for each of the video window requests, determining one or more focal plane array (FPA) regions of interest (ROIs) sufficient to fulfill the requests by using request parameters and a geometric sensor model;
for each of the video window requests, processing, at a corresponding node of an image processing subsystem of the CFPA imaging system, image data from the ROIs according to the video window request;
wirelessly transmitting, from the image processing subsystem to the remote server, the image data processed by the image processing subsystem; and
delivering, by the remote server over a network to the different clients, the image data for live video windows for the respective clients.

13. The method of claim 12, wherein each video window request is assigned by the image processing subsystem to a corresponding node and the nodes process the image data for their video window request in parallel.

14. The method of claim 13, wherein processing of the image data at each node comprises one or more of the following operations: non-uniformity correction, video stream region of interest (ROI) selection and distribution, color interpolation and transformation, contrast and imagery enhancement, geometric video image formation, and jitter stabilization.

15. The method of claim 13, wherein each node processes image data corresponding only to the video window assigned to that node.

16. The method of claim 15, wherein the live video windows are delivered to the clients while the airborne platform moves relative to the scene.

17. A method for simultaneously providing multiple live video windows to different clients from an airborne platform, the method comprising:
acquiring a sequence of image frames using a composite focal plane array (CFPA) imaging system of a scene, wherein the CFPA imaging system is a part of the airborne platform;
receiving onto a wireless communications module of the CFPA imaging system from a remote server via a wireless transmission a request for a live video window;
communicating the live video window request from the wireless communications module across a network to a first graphics processing unit (GPU) of the CFPA imaging system, wherein the first GPU is one of a plurality of exploitation GPUs of the CFPA imaging system, and wherein the CFPA imaging system further comprises a special geometric sensor model maintaining and updating GPU;
communicating a request for a geometric sensor model update across the network from the first GPU to the special GPU;
communicating the gemetric sensor model update across the network from the special GPU to the first GPU;
for the live video window request using the geometric sensor model update on the first GPU to determine one or more focal plane array (FPA) regions of interest (ROIs) sufficient to fulfill the request;
communicating ROI requests for the determined ROIs of interest across the network from the first GPU to others of the exploitation GPUs;
communicating image data in response to the ROI requests across the network from the other of the exploitation GPUs back to the first GPU such that not all image data of the entire composite CFPA image of the scene is communicated across the network;
stitching together image data on the first GPU in order to satisfy the live video request; and
wirelessly transmitting, from the airborne platform to the remote server, the stitched together image data.
